(19) United States
(12) Patent Application Publication
(10) Pub. No.: US 2020/0213838 A1
(43) Pub. Date: Jul. 2, 2020

(54) Method and Apparatus for Communication Authentication Processing, and Electronic Device

(71) Applicant: Baidu Online Network Technology (Beijing) Co., Ltd., Beijing (CN)

(72) Inventors: Peng WANG, Beijing (CN); Guoguo CHEN, Beijing (CN); Fei NIU, Beijing (CN); Ziqiang ZHU, Beijing (CN); Yin LONG, Beijing (CN)

(73) Assignee: Baidu Online Network Technology (Beijing) Co., Ltd., Beijing (CN)

(21) Appl. No.: 16/720,754

(22) Filed: Dec. 19, 2019

(30) Foreign Application Priority Data
Jan. 2, 2019 (CN) 201910000687.1

(51) Int. Cl. H04W 12/00; H04W 12/06; H04W 76/10; H04W 4/80

(52) U.S. Cl. CPC H04W 12/003; H04W 4/80; H04W 76/10; H04W 12/06

(57) ABSTRACT

Embodiments of the present disclosure provide a method and apparatus for communication authentication processing, and an electronic device, where the method includes: transmitting, by a first device, a pairing request to a second device; receiving, by the first device, a pairing response transmitted by the second device, where the pairing response includes a first random value and first signature information, the first random value is configured to generate the first signature information; and acquiring, by the first device, a second random value and second signature information from a server according to the first random value and the first signature information, where the second random value and the second signature information are generated by the server according to the first random value and the first signature information, the second random value is configured to generate the second signature information.

### CROSS-REFERENCE TO RELATED APPLICATION

This application claims priority to Chinese Patent Application No. 201910000687.1, filed on Jan. 2, 2019, which is hereby incorporated by reference in its entirety.

### TECHNICAL FIELD

Embodiments of the present disclosure relate to communication technologies, and in particular, to a method and apparatus for communication authentication processing, and an electronic device.

### BACKGROUND

In the field of wireless communication, it is necessary to support long-distance wireless communication as well as short-distance communication between devices. The short-distance communication may be, for example, a data communication between devices within a building or a home. It is necessary to accomplish a data interaction between devices based on a specific communication protocol, a Bluetooth protocol is a communication protocol supported by many devices.

In the prior art, when devices perform communication based on the Bluetooth protocol, they mainly experience processes of scanning (master device), broadcasting (slave device), establishing a communication connection, and a data interaction.

However, existing Bluetooth communication has shortcomings in communication security.

### SUMMARY

Embodiments of the present disclosure provide a method and apparatus for communication authentication processing, and an electronic device, and technical solutions are as follows.

A first aspect of the embodiments of the present disclosure provides a method for communication authentication processing, including:

transmitting, by a first device, a pairing request to a second device;

receiving, by the first device, a pairing response transmitted by the second device, where the pairing response includes a first random value and first signature information, the first random value is configured to generate the first signature information;

acquiring, by the first device, a second random value and second signature information from a server according to the first random value and the first signature information, where the second random value and the second signature information are generated by the server according to the first random value and the first signature information, the second random value is configured to generate the second signature information; and

performing, by the first device, a data interaction with the second device according to the second random value and the second signature information.

Further, the performing, by the first device, a data interaction with the second device according to the second random value and the second signature information, includes:

transmitting, by the first device, a request for providing data to the second device, where the request for providing data includes the second random value and the second signature information; and

receiving, by the first device, response data transmitted by the second device when the first signature information matches the second signature information.

Further, the method further includes:

transmitting, by the first device, a request for acquiring data to the server, where the request for acquiring data is configured to request first data in response to the response data, the request for acquiring data includes the response data, the first random value and the first signature information; and

receiving, by the first device, the first data transmitted by the server when the first signature information matches the second signature information.

Further, the second signature information is obtained according to the historical second signature information.

Further, the data interaction is a voice-based data interaction, and the response data is voice data.

A second aspect of the embodiments of the present disclosure provides a method for communication authentication processing, including:

receiving, by a second device, a pairing request transmitted by a first device;

generating, by the second device, a first random value and first signature information according to the pairing request, where the first random value is configured to generate the first signature information;

transmitting, by the second device, a pairing response to the first device, where the pairing response includes the first random value and the first signature information, so that the first device acquires a second random value and second signature information from a server according to the first random value and the first signature information; and

performing, by the second device, a data interaction with the first device according to the second random value and the second signature information.

Further, the performing, by the second device, a data interaction with the first device according to the second random value and the second signature information, includes:

receiving, by the second device, a request for providing data transmitted by the first device, where the request for providing data includes the second random value and the second signature information, the second random value is configured to generate the second signature information;

performing, by the second device, a signature information comparison on the first signature information and the second signature information according to the first random value, the first signature information, the second random value, and the second signature information, to obtain a comparison result; and

transmitting, by the second device, response data to the first device if the comparison result is that the signature information matches.

Further, the transmitting, by the second device, a pairing response to the first device, includes:

determining, by the second device, whether it is currently in a pairing mode, and if so, transmits the pairing response to the first device.

Further, after the transmitting, by the second device, a pairing response to the first device, the method further includes:

switching, by the second device, from the pairing mode to a non-pairing mode.

Further, the data interaction is a voice-based data interaction, and the response data is voice data.

A third aspect of the embodiments of the present disclosure provides an apparatus for communication authentication processing, applied to a first device, and including:

a transmitting module, configured to transmit a pairing request to a second device;

a receiving module, configured to receive a pairing response transmitted by the second device, where the pairing response includes a first random value and first signature information, the first random value is configured to generate the first signature information;

an acquiring module, configured to acquire a second random value and second signature information from a server according to the first random value and the first signature information, where the second random value and the second signature information are generated by the server according to the first random value and the first signature information, the second random value is configured to generate the second signature information; and

an interacting module, configured to perform a data interaction with the second device according to the second random value and the second signature information.

Further, the interacting module includes:

a transmitting unit, configured to transmit a request for providing data to the second device, where the request for providing data includes the second random value and the second signature information; and

a receiving unit, configured to receive response data transmitted by the second device when the first signature information matches the second signature information.

Further, the transmitting module is further configured to:

transmit a request for acquiring data to the server, where the request for acquiring data is configured to request first data in response to the response data, the request for acquiring data includes the response data, the first random value, and the first signature information; and

the receiving module is further configured to: receive the first data transmitted by the server when the first signature information matches the second signature information.

Further, the second signature information is obtained according to the historical second signature information.

Further, the data interaction is a voice-based data interaction, and the response data is voice data.

A fourth aspect of the embodiments of the present disclosure provides an apparatus for communication authentication processing, applied to a second device, and including:

a receiving module, configured to receive a pairing request transmitted by a first device;

a generating module, configured to generate a first random value and first signature information according to the pairing request, where the first random value is configured to generate the first signature information;

a transmitting module, configured to transmit a pairing response to the first device, where the pairing response includes the first random value and the first signature information, so that the first device acquires a second random value and second signature information from a server according to the first random value and the first signature information; and

an interacting module, configured to perform a data interaction with the first device according to the second random value and the second signature information.

Further, the interacting module includes:

a receiving unit, configured to receive a request for providing data transmitted by the first device, where the request for providing data includes the second random value and the second signature information, the second random value is configured to generate the second signature information;

a comparing unit, configured to perform a signature information comparison on the first signature information and the second signature information according to the first random value, the first signature information, the second random value, and the second signature information, to obtain a comparison result; and

a transmitting unit, configured to transmit response data to the first device when the comparison result is that the signature information matches.

Further, the transmitting module is specifically configured to:

determine whether it is currently in a pairing mode, and if so, transmit the pairing response to the first device.

Further, the apparatus further includes:

a switching module, configured to switch from the pairing mode to a non-pairing mode.

Further, the data interaction is a voice-based data interaction, and the response data is voice data.

A fifth aspect of the embodiments of the present disclosure provides an electronic device, including:

a memory, configured to store program instructions; and

a processor, configured to invoke and execute the program instructions in the memory, so as to perform the steps of the method of the first aspect or the second aspect as described above.

A sixth aspect of the embodiments of the present disclosure provides a readable storage medium, where the readable storage medium stores therein a computer program for performing the steps of the method of the first aspect or the second aspect as described above.

In the method, apparatus for communication authentication processing and the electronic device provided by the embodiments of the present disclosure, when a first device is paired with a second device, the second device generates a first random value and first signature information, and the first device then acquires a second random value and second signature information from a server using the first random value and the first signature information, and the first device then performs a data interaction with the second device using the second random value and the second signature information, so as to determine whether a data request is legal based on the signature information, and only a legal request can obtain a response, thereby ensuring security of the interaction process.

### BRIEF DESCRIPTION OF DRAWINGS

In order to more clearly illustrate the technical solutions in embodiments of the present disclosure or in the prior art, the drawings needed to be used in the description of the embodiments or the prior art will be briefly described below. Obviously, the drawings in the following description are some embodiments of the present disclosure, and for those skilled in the art, other drawings can be obtained according to these drawings without any creative effort.

FIG. 1 is a system architecture diagram of a method for communication authentication processing involved in an embodiment of the present disclosure;

FIG. 2 is a schematic flowchart diagram of embodiment 1 of a method for communication authentication processing according to an embodiment of the present disclosure;

FIG. 3 is a schematic flowchart diagram of embodiment 2 of a method for communication authentication processing according to an embodiment of the present disclosure;

FIG. 4 is a schematic flowchart diagram of embodiment 3 of a method for communication authentication processing according to an embodiment of the present disclosure;

FIG. 5 is a schematic flowchart diagram of embodiment 4 of a method for communication authentication processing according to an embodiment of the present disclosure;

FIG. 6 is a schematic flowchart diagram of embodiment 5 of a method for communication authentication processing according to an embodiment of the present disclosure;

FIG. 7 is an interaction flowchart of a method for communication authentication processing according to an embodiment of the present disclosure;

FIG. 8 is a modular structural diagram of an apparatus for communication authentication processing according to an embodiment of the present disclosure;

FIG. 9 is a modular structural diagram of an apparatus for communication authentication processing according to an embodiment of the present disclosure;

FIG. 10 is a modular structural diagram of another apparatus for communication authentication processing according to an embodiment of the present disclosure;

FIG. 11 is a modular structural diagram of another apparatus for communication authentication processing according to an embodiment of the present disclosure;

FIG. 12 is a modular structural diagram of another apparatus for communication authentication processing according to an embodiment of the present disclosure;

FIG. 13 is an entity block diagram of an electronic device according to an embodiment of the present disclosure.

### DESCRIPTION OF EMBODIMENTS

In order to make the objects, technical solutions and advantages of embodiments of the present disclosure more clear, the technical solutions in the embodiments of the present disclosure will be clearly and completely described in combination with the drawings in the embodiments of the present disclosure. It is apparent that the described embodiments are part of the embodiments of the present disclosure, but not all of the embodiments. All other embodiments obtained by those skilled in the art based on the embodiments of the present disclosure without ant creative effort are within the protection scope of the present disclosure.

In an existing communication process, after a terminal device and a Bluetooth peripheral establish a communication connection, during a data interaction process, no authentication processing is performed among the terminal device, the Bluetooth peripheral and a server, and therefore, there is a shortcoming in security.

Based on the above problem, a method for communication authentication processing is provided in embodiments of the present disclosure. Authentication information is transmitted between devices at the beginning of pairing of the devices, and it is determined whether an interaction process is legal between the devices based on the authentication information in subsequent various stages, which ensures the security of the interaction process.

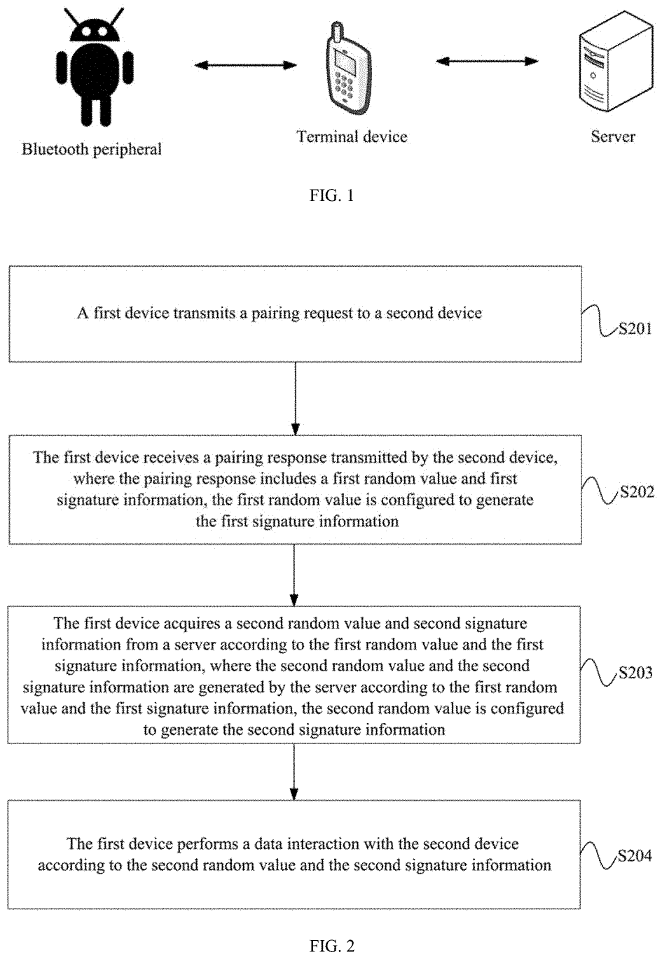

FIG. 1 is a system architecture diagram of a method for communication authentication processing involved in an embodiment of the present disclosure. As shown in FIG. 1, the method relates to a terminal device, a Bluetooth peripheral, and a server in a cloud. The terminal device has the ability to connecting to an Internet, for example, the terminal device may transmit a request for acquiring data to a device such as a server in the Internet, and receive data transmitted by the device in the Internet. The terminal device may be, for example, a mobile phone, a tablet, or the like. The Bluetooth peripheral may not have the ability to connect to the Internet, or it may have the ability to connect to the Internet while has the ability of voice reception or audio playing. The Bluetooth peripheral may be, for example, an intelligent speaker with a built-in microphone, an intelligent car holder, or the like. Both the terminal device and the Bluetooth peripheral support a Bluetooth protocol, and may perform a data interaction based on Bluetooth. The server may be a server in the Internet that can provide the requested data to the terminal device.

Taking the Bluetooth peripheral being an intelligent car holder as an example, in an exemplary application scenario, a user is located within a vehicle, and the intelligent car holder is installed in the vehicle, and at the same time, the user places a carried mobile phone in the vehicle, the user then may trigger the mobile phone to scan a surrounding Bluetooth peripheral through a specific operation, and connect with the intelligent car holder according to an instruction of the user. After the connection, the mobile phone performs an authentication processing procedure with the connected intelligent car holder through the method provided by the embodiment of the present disclosure, and a voice instruction issued by the user to the intelligent car holder can obtain a response only when the authentication is successful. For example, the user can speak a specific awakening word toward the intelligent car holder to awaken the intelligent car holder, after the intelligent car holder is awakened, the user can issue a voice instruction to the intelligent car holder, for example, “Please help me check the weather of tomorrow”, the intelligent car holder may transmit the voice instruction to the terminal device, and the terminal device analyzes the voice instruction, and converts it into a request for acquiring data for transmitting to the server device in the Internet. After receiving data returned by the server, the terminal device returns the data to the intelligent car holder, and the data is played to the user by the intelligent car holder.

The following embodiments of the present disclosure illustrate the technical solutions of the embodiments of the present disclosure from the perspective of a first device, a second device and an interaction thereof.

A processing procedure of the first device side will first be described below.

FIG. 2 is a schematic flowchart diagram of embodiment 1 of a method for communication authentication processing according to an embodiment of the present disclosure. An execution body of the method is a first device, and the first device may be the above terminal device. As shown in FIG. 2, the method includes:

S201. The first device transmits a pairing request to a second device.

In the embodiment of the present disclosure, the first device has the ability to connect to an Internet, for example, may be the terminal device shown in FIG. 1, and the second device has the ability of voice reception or audio playing, and may also has the ability to connect to the Internet, for example, may be the Bluetooth peripheral shown in FIG. 1, and the second device may not have the ability to connect to the Internet.

In an embodiment, before this step, a communication connection has been established between the first device and the second device.

In an embodiment, the first device and the second device establish a communication connection on a Radio Frequency Communication (RFCOMM) link.

Further, in this step, in an embodiment, after receiving an operation instruction of a user, the first device triggers transmission of a pairing request to the second device. The operation instruction of the user may be, for example, a click operation of the user for the second device on an interface of an application (abbreviated as APP) of the first device. Specifically, after the first device has scanned the second device, the first device displays information such as a name of the second device on the interface of the APP, and simultaneously displays a connection button. After the user clicks the connection button, the first device is triggered to establish a communication connection with the second device. After the connection is established, the user performs a click operation at a location where the information of the second device is displayed, to trigger the first device to initiate a pairing request to the second device.

S202. The first device receives a pairing response transmitted by the second device, where the pairing response includes a first random value and first signature information, the first random value is configured to generate the first signature information.

After receiving the pairing request of the first device, the second device may generate a first random value, and generate first signature information based on the first random value and a preset algorithm. The specific process will be illustrated in detail in the corresponding embodiment of the second device described below.

After generating the first signature information, the second device returns the first random value and the first signature information to the first device.

In an embodiment, the second device may further transmit an identifier of the algorithm for generating the first signature information to the first device, so that a server interacting with the first device generates second signature information based on the same algorithm.

In an embodiment, the second device may save the generated first random value, and in a subsequent interaction process, the second device performs an authentication processing based on this first random value. After the second device is reset, the second device regenerates a new first random value.

S203. The first device acquires a second random value and the second signature information from the server according to the first random value and the first signature information, where the second random value and the second signature information are generated by the server according to the first random value and the first signature information, and the second random value is configured to generate the second signature information.

In an embodiment, after receiving the pairing response, the first device may transmit a request for signature verification to the server, and the first random value and the first signature information are carried in the request for signature verification, and the identifier of the algorithm for generating the first signature information may also be carried in the request for signature verification. After receiving the request for signature verification, the server first generates the second random value, which may be an 8-bit random string, further, the server generates the second signature information based on the same algorithm as the second device.

In an embodiment, the server generates the second signature information using the following formula (1):

sign2=sign_method(rand2+rand+key+product_id+serial_number) (1)

where, sign_method is an algorithm identifier, rand2 is the second random value, rand is the first random value, key and product_id are parameter values previously assigned by the server for the second device, and serial number is a serial number of the current interaction.

After generating the second signature information, the server returns the second random value and the second signature information to the first device.

S204. The first device performs a data interaction with the second device according to the second random value and the second signature information.

In an embodiment, the data interaction may be a voice-based data interaction, and may be a data interaction based on an interface operation, which is not specifically limited in this embodiment of the present disclosure.

After the above steps, the first device acquires the first random value and the first signature information generated by the second device, and the second random value and the second signature information generated by the server, and the first device saves these information.

In an embodiment, the first device may perform the data interaction with the second device based on the second random value and the second signature information under a triggering of an operation instruction of the user or the server.

In this embodiment, when a first device is paired with a second device, the second device generates a first random value and first signature information, and the first device then acquires a second random value and second signature information from a server using the first random value and the first signature information, and the first device then performs a data interaction with the second device using the second random value and the second signature information, so as to determine whether a data request is legal based on the signature information, and only a legal request can obtain a response, thereby ensuring security of the interaction process.

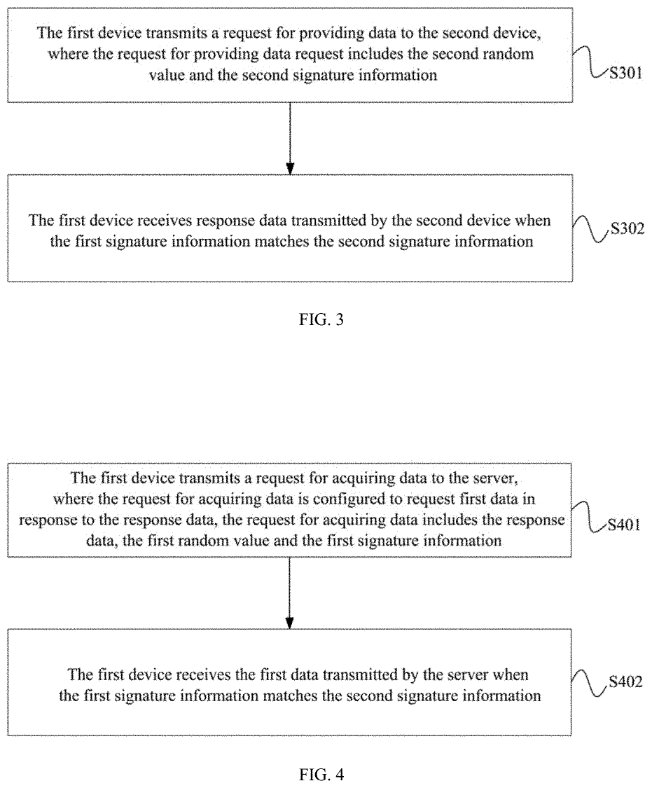

FIG. 3 is a schematic flowchart diagram of embodiment 2 of a method for communication authentication processing according to an embodiment of the present disclosure. As shown in FIG. 3, an optional manner of the above step S204 includes:

S301. The first device transmits a request for providing data to the second device, where the request for providing data includes the second random value and the second signature information.

In an optional manner, when the user performs an operation such as clicking a confirmation button on the interface of the APP, this step may be triggered to be performed.

In another optional manner, when the server needs to clarify an intention of the user, the first device may also be instructed to perform this step.

After the first device transmits the request for providing data to the second device, the second device may determine to transmit a voice or data in other forms to the first device. Taking a voice as an example, the voice may be a voice instruction such as querying weather information, playing a specific song, or the like.

S302. The first device receives response data transmitted by the second device when the first signature information matches the second signature information.

The first device carries the second random value and the second signature information when transmitting the request for providing data, and the second device determines whether the second signature information matches the first signature information previously generated by the second device using the algorithm for generating the first signature information, if it matches, the response data is returned to the first device, thereby an authentication processing on the second device side is accomplished.

In an embodiment, the above response data may be voice data.

It should be noted that, in the specific implementation process, the first device, when in a pairing state with the second device, may need to perform the processes of the foregoing S301-S302 for multiple times, that is, transmit the request for providing data to the second device for multiple times.

Since the first device may need to transmit the request for providing data request to the second device for multiple times in a specific implementation process, the second signature information generated by the server may be repeatedly used and transmitted, thereby possibly causing the second signature information to be sniffed by an illegal attacker and the sniffed second signature information to be used to initiate an attack by the illegal attacker. In order to solve this problem, in the embodiment of the present disclosure, after the server first generates the second signature information using the above formula (1), in a subsequent process, when the server regenerates second signature information and the second device uses the second signature information to perform verification, the second signature information may be generated using the following formula (2):

new_sign2=sign_method(sign2+requestId+int2string(command)) (2)

where, sign2 is the second signature information obtained in the last calculation before the current calculation, and requestID is the current request identifier currently triggering the current calculation, and common is an instruction identifier corresponding to the current request.

Through the processing of the above formula (2), the second signature information used in each interaction may be obtained according to historical second signature information, so that the second signature information used each time is not duplicated with the historical second signature information, thereby preventing the second signature information from being sniffed by an attacker, and further ensuring the security of the interaction process.

In an embodiment, after receiving the response data transmitted by the second device, the first device may interact with the server using the following method.

FIG. 4 is a schematic flowchart diagram of embodiment 3 of a method for communication authentication processing according to an embodiment of the present disclosure. As shown in FIG. 4, the above method further includes:

S401. The first device transmits a request for acquiring data to the server, where the request for acquiring data is configured to request first data in response to the response data, the request for acquiring data includes the response data, the first random value and the first signature information.

In an embodiment, after receiving the response data, the first device performs a semantic analysis on the response data to obtain a corresponding instruction, if the instruction is configured to request the first data from the server, the first device then transmits the request for acquiring data to the server, and carries the first random value generated by the second device and the second random value in the request.

S402. The first device receives the first data transmitted by the server when the first signature information matches the second signature information.

In an embodiment, after receiving the request for acquiring data, the server first uses an algorithm for generating the second signature information to determine whether the first signature information carried in the request matches the second signature information previously generated by the server, and if it matches, returns the first data to the first device, thereby an authentication processing on the server side is accomplished.

In another embodiment, if the first device has accomplished pairing with the second device, and saves the first random value and the first signature information generated by the second device, then if the communication connection between the first device and the second device are triggered again due to some specific operations by this time, after the communication connection is accomplished, the first device determines whether there are the first random value and the first signature information, if there are, the first device does not interact with the server anymore, but directly uses the first random value and the first signature information obtained after the last pairing is accomplished, and the second random value and the second signature information.

The following is a processing procedure on the second device side.

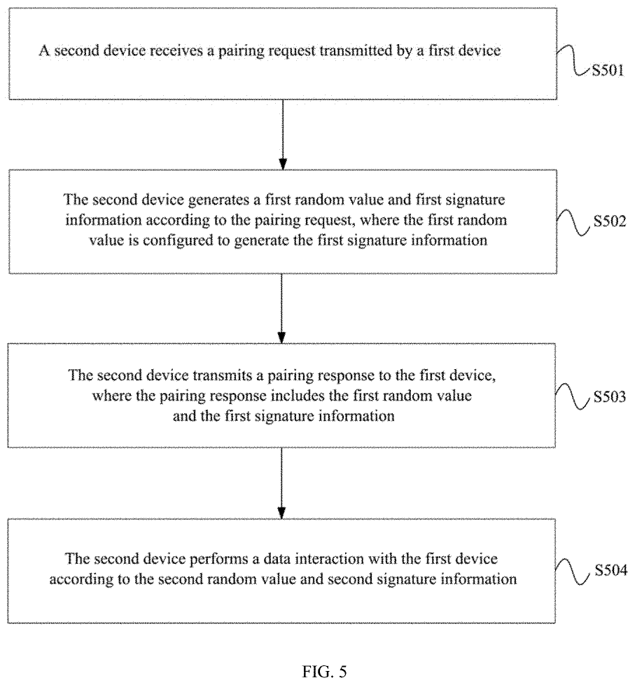

FIG. 5 is a schematic flowchart diagram of embodiment 4 of a method for communication authentication processing according to an embodiment of the present disclosure. An execution body of the method is the second device, and the second device may be the Bluetooth peripheral described in FIG. 1. As shown in FIG. 5, the method includes:

S501. The second device receives a pairing request transmitted by a first device.

S502. The second device generates a first random value and first signature information according to the pairing request, where the first random value is configured to generate the first signature information.

In an embodiment, the second device may generate the first signature information using the following formula (3):

sign=sign_method(rand+key+product_id+serial_number) (3)

where, sign_method is an algorithm identifier, and the algorithm may be, for example, SHA256, SHA1, MD5SUM, or the like. rand is the first random value, and the first random number can be an 8-bit random string. key and product_id are parameter values previously assigned by a server to the second device, and serial_number is a serial number of the current interaction.

S503. The second device transmits a pairing response to the first device, where the pairing response includes the first random value and the first signature information.

After the second device transmits the pairing response to the first device, the first device is triggered to acquire a second random value and second signature information from the server according to the first random value and the first signature information.

S504. The second device performs a data interaction with the first device according to the second random value and the second signature information.

As can be seen from the embodiment of the first device side, after receiving the pairing response, the first device may interact with the server, and the server generates the second random value and the second signature information. Further, the first device and the second device perform the data interaction based on the second random value and the second signature information.

In this embodiment, when a first device is paired with a second device, the second device generates the first random value and the first signature information, and the first device then obtains a second random value and second signature information from a server using the first random value and the first signature information, and the second device then performs a data interaction with the first device using the second random value and the second signature information, so as to determine whether a data request is legal based on the signature information, and only a legal request can obtain a response, thereby ensuring the security of the interaction process.

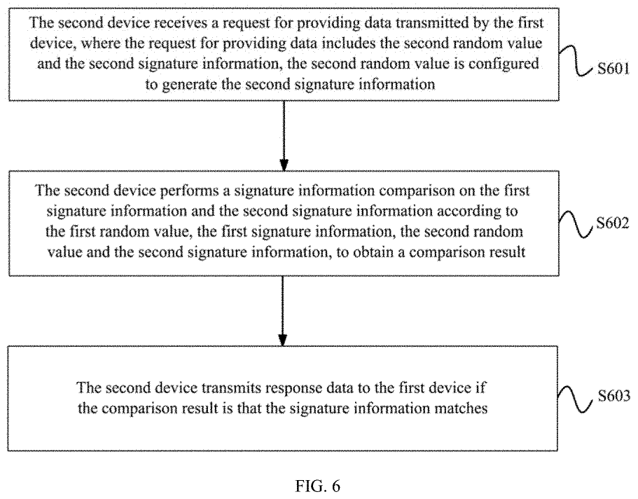

FIG. 6 is a schematic flowchart diagram of embodiment 5 of a method for communication authentication processing according to an embodiment of the present disclosure. As shown in FIG. 6, an optional manner of the above step S504 includes:

S601. The second device receives a request for providing data transmitted by the first device, where the request for providing data includes the second random value and the second signature information, the second random value is configured to generate the second signature information.

S602. The second device performs a signature information comparison on the first signature information and the second signature information according to the first random value, the first signature information, the second random value, and the second signature information, to obtain a comparison result.

In an embodiment, the second device may perform the signature information comparison on the second signature information and the first signature information previously generated by the second device using an algorithm for generating the first signature information.

S603. The second device transmits response data to the first device if the comparison result is that the signature information matches.

In a specific implementation process, for a second device, it can only pair with one first device at the same time, so as to ensure normal data interaction, therefore, the second device needs to control pairing. As an optional implementation, in the embodiment, a mode attribute may be added to the second device. A mode of the second device may include a pairing mode and a non-pairing mode, and the second device can only be in one of the modes at the same time. In an initial state, for example, after an initiating of the second device is accomplished, the second device is in the pairing mode, in which the second device can be paired with other devices. That is, in the above step S501, after receiving the pairing request transmitted by the first device, the second device may determine whether it is currently in the pairing mode, and if yes, the second device may transmit the pairing response to the first device to pair with the first device. Further, after transmitting the pairing response to the first device, the second device switches from the pairing mode to the non-pairing mode. In the non-pairing mode, if the second device receives a pairing request, it rejects the pairing, and returns response information for rejecting pairing to a device that transmits the pairing request.

By setting the mode attribute for the second device, the second device can be paired and subsequently interacted with other devices only in the pairing mode, thereby avoiding a run error of the second device.

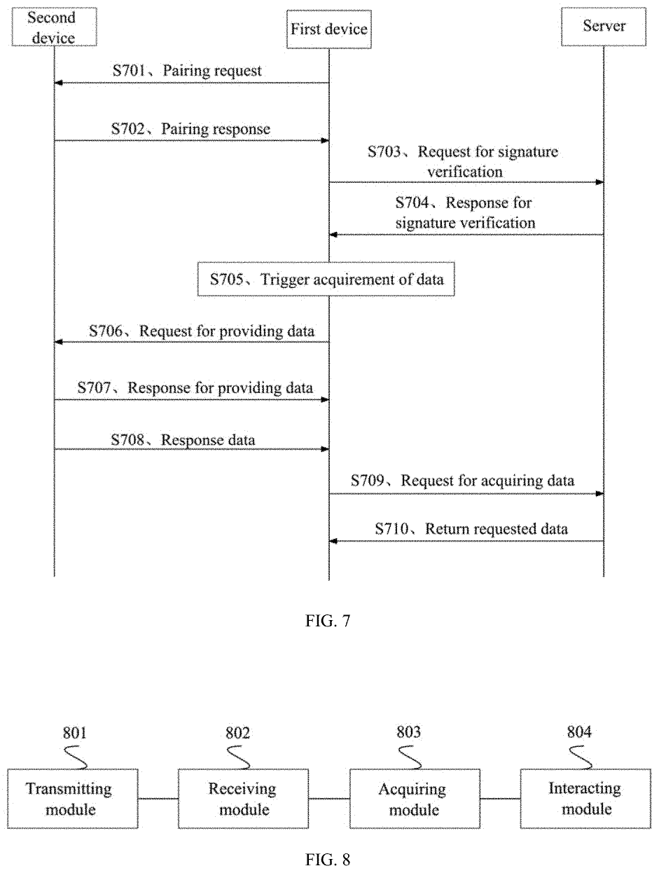

FIG. 7 is an interaction flowchart of a method for communication authentication processing according to an embodiment of the present disclosure. As shown in FIG. 7, the interaction process involved in the method is:

S701. A first device initiates a pairing request to a second device.

S702. The second device returns a pairing response to the first device, where the pairing response includes a first random value and first signature information.

S703. The first device transmits a request for signature verification to a server which includes the first random value and the first signature information.

S704. The server returns a response for signature verification to the first device which includes a second random value and second signature information.

S705: The first device triggers acquirement of data, where the data may be a voice.

S706. The first device transmits a request for providing data to the second device which includes the second random value and the second signature information.

S707. A verification of the second device passes, and the second device returns a response for providing data to the first device.

S708. The second device transmits response data to the first device.

S709. The first device transmits a request for acquiring data to the server which includes the first random value and the first signature information.

S710. A verification of the server passes, and the server returns requested data to the first device.

For the specific implementation process of the above steps, reference may be made to the description of the above embodiments, and details are not described herein again.

FIG. 8 is a modular structural diagram of an apparatus for communication authentication processing according to an embodiment of the present disclosure, which is applied to a first device, and as shown in FIG. 8, includes:

a transmitting module 801, configured to transmit a pairing request to a second device;

a receiving module 802, configured to receive a pairing response transmitted by the second device, where the pairing response includes a first random value and first signature information, where the first random value is configured to generate the first signature information;

an obtaining module 803, configured to acquire a second random value and second signature information from a server according to the first random value and the first signature information, where the second random value and the second signature information are generated by the server according to the first random value and the first signature information, and the second random value is configured to generate the second signature information; and

an interacting module 804, configured to perform a data interaction with the second device according to the second random value and the second signature information.

The apparatus is configured to implement the above embodiments of the method, and the implementation principle and technical effects thereof are similar, and details are not described herein again.

FIG. 9 is a modular structural diagram of an apparatus for communication authentication processing according to an embodiment of the present disclosure. As shown in FIG. 9, the interacting module 804 includes:

a transmitting unit 8041, configured to transmit a request for providing data to the second device, where the request for providing data includes the second random value and the second signature information; and

a receiving unit 8042, configured to receive response data transmitted by the second device when the first signature information matches the second signature information.

In another embodiment, the transmitting module 801 is further configured to:

transmit a request for acquiring data to the server, where the request for acquiring data is configured to request first data in response to the response data, the request for acquiring data includes the response data, the first random value, and the first signature information; and

the receiving module 802 is further configured to: receive the first data transmitted by the server when the first signature information matches the second signature information.

In another embodiment, the second signature information is obtained according to the historical second signature information.

In another embodiment, the data interaction is a voice-based data interaction, and the response data is voice data.

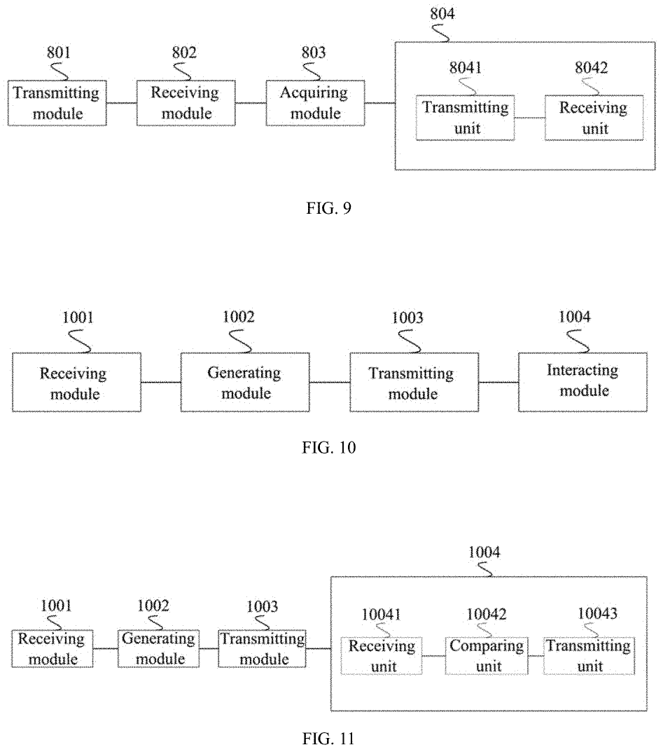

FIG. 10 is a modular structural diagram of another apparatus for communication authentication processing according to an embodiment of the present disclosure, which is applied to a second device, and as shown in FIG. 10, includes:

a receiving module 1001, configured to receive a pairing request transmitted by a first device;

a generating module 1002, configured to generate a first random value and first signature information according to the pairing request, where the first random value is configured to generate the first signature information;

a transmitting module 1003, configured to transmit a pairing response to the first device, where the pairing request includes the first random value and the first signature information, so that the first device acquires a second random value and second signature information from a server according to the first random value and the first signature information; and

an interacting module 1004, configured to perform a data interaction with the first device according to the second random value and the second signature information.

The apparatus is configured to implement the above embodiments of the method, and the implementation principle and technical effects thereof are similar, and details are not described herein again.

FIG. 11 is a modular structural diagram of another apparatus for communication authentication processing according to an embodiment of the present disclosure. As shown in FIG. 11, the interacting module 1004 includes:

a receiving unit 10041, configured to receive a request for providing data transmitted by the first device, where the request for providing data includes the second random value and the second signature information, the second random value is configured to generate the second signature information;

a comparing unit 10042, configured to perform a signature information comparison on the first signature information and the second signature information according to the first random value, the first signature information, the second random value, and the second signature information, to obtain a comparison result; and

a transmitting unit 10043, configured to transmit response data to the first device when the comparison result is that the signature information matches.

In another embodiment, the transmitting module 1003 is specifically configured to:

determine whether it is currently in the pairing mode, and if so, transmit the pairing response to the first device.

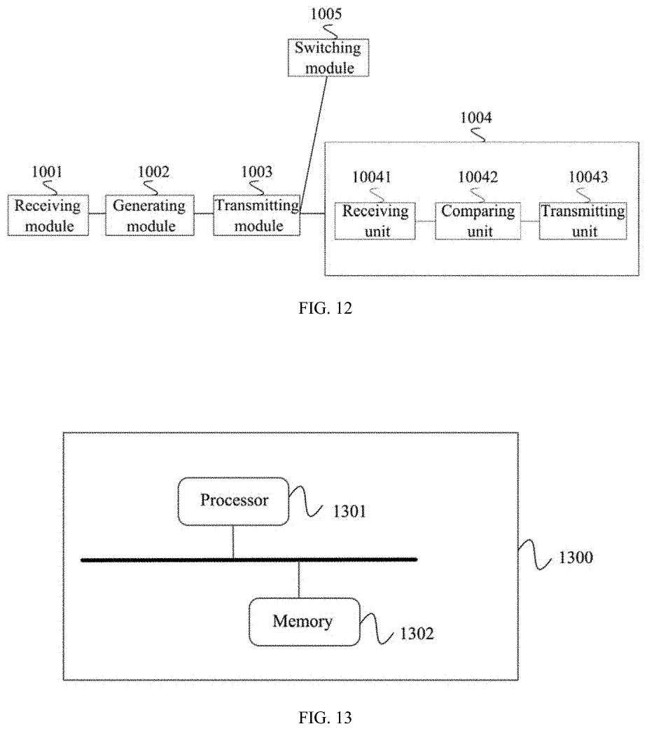

FIG. 12 is a modular structural diagram of another apparatus for communication authentication processing according to an embodiment of the present disclosure. As shown in FIG. 12, further includes:

a switching module 1005, configured to switch from the pairing mode to a non-pairing mode.

In another embodiment, the data interaction is a voice-based data interaction, and the response data is voice data.

FIG. 13 is an entity block diagram of an electronic device according to an embodiment of the present disclosure. As shown in FIG. 13, the electronic device 1300 includes:

a memory 1301, configured to store program instructions; and

a processor 1302, configured to invoke and execute the program in the memory 1301, so as to perform the steps of the method executed by the first device in the above embodiments of the method, or to perform the steps of the method executed by the second device in the above embodiments of the method.

Those skilled in the art will appreciate that all or part of the steps for implementing the various embodiments of the method described above may be accomplished by hardware associated with program instructions. The aforementioned program can be stored in a computer readable storage medium. The program, when executed, performs the steps including the foregoing method embodiments; and the foregoing storage medium includes various medium that can store program codes, such as a ROM, a RAM, a magnetic disk, or an optical disk.

Finally, it should be noted that the above embodiments are merely used to illustrate the technical solutions of the present disclosure, and are not intended to be limiting thereto; although the present disclosure has been described in detail with reference to the foregoing embodiments, those skilled in the art will understand that the technical solutions described in the foregoing embodiments may be modified, or some or all of the technical features may be equivalently substituted; and the modifications or substitutions do not deviate the corresponding technical solutions from the scope of the technical solutions of the embodiments of the present disclosure.

What is claimed is:

1. A method for communication authentication processing, comprising:
transmitting, by a first device, a pairing request to a second device;
receiving, by the first device, a pairing response transmitted by the second device, wherein the pairing response comprises a first random value and first signature information, the first random value is configured to generate the first signature information;
acquiring, by the first device, a second random value and second signature information from a server according to the first random value and the first signature information, wherein the second random value and the second signature information are generated by the server according to the first random value and the first signature information, the second random value is configured to generate the second signature information; and
performing, by the first device, a data interaction with the second device according to the second random value and the second signature information.

2. The method according to claim 1, wherein the performing, by the first device, a data interaction with the second device according to the second random value and the second signature information, comprises:
transmitting, by the first device, a request for providing data to the second device, wherein the request for providing data comprises the second random value and the second signature information.

3. The method according to claim 2, wherein the performing, by the first device, a data interaction with the second device according to the second random value and the second signature information, further comprises:
receiving, by the first device, response data transmitted by the second device when the first signature information matches the second signature information.

4. The method according to claim 3, further comprising:
transmitting, by the first device, a request for acquiring data to the server, wherein the request for acquiring data is configured to request first data in response to the response data, the request for acquiring data comprises the response data, the first random value and the first signature information.

5. The method according to claim 4, further comprising:
receiving, by the first device, the first data transmitted by the server when the first signature information matches the second signature information.

6. The method according to claim 1, wherein the second signature information is obtained according to historical second signature information.

7. The method according to claim 2, wherein the data interaction is a voice-based data interaction, and the response data is voice data.

8. An apparatus for communication authentication processing, applied to a first device, and comprising:
a memory, a processor, and a computer program stored on the memory and operable on the processor,
wherein the processor, when running the computer program, is configured to:
transmit a pairing request to a second device;
receive a pairing response transmitted by the second device, wherein the pairing response comprises a first random value and first signature information, the first random value is configured to generate the first signature information;
acquire a second random value and second signature information from a server according to the first random value and the first signature information, wherein the second random value and the second signature information are generated by the server according to the first random value and the first signature information, the second random value is configured to generate the second signature information; and
perform a data interaction with the second device according to the second random value and the second signature information.

9. The apparatus according to claim 8, wherein the processor is further configured to:
transmit a request for providing data to the second device, wherein the request for providing data comprises the second random value and the second signature information.

10. The apparatus according to claim 9, wherein the processor is further configured to:
receive response data transmitted by the second device when the first signature information matches the second signature information.

11. The apparatus according to claim 10, wherein the processor is further configured to:
transmit a request for acquiring data to the server, wherein the request for acquiring data is configured to request first data in response to the response data, the request for acquiring data comprises the response data, the first random value and the first signature information.

12. The apparatus according to claim 11, wherein the processor is further configured to:
receive the first data transmitted by the server when the first signature information matches the second signature information.

13. The apparatus according to claim 8, wherein the second signature information is obtained according to historical second signature information.

14. The apparatus according to claim 9, wherein the data interaction is a voice-based data interaction, and the response data is voice data.

15. An apparatus for communication authentication processing, applied to a second device, and comprising:
a memory, a processor, and a computer program stored on the memory and operable on the processor,
wherein the processor, when running the computer program, is configured to:
receive a pairing request transmitted by a first device;
generate a first random value and first signature information according to the pairing request, wherein the first random value is configured to generate the first signature information;
transmit a pairing response to the first device, wherein the pairing response comprises the first random value and the first signature information, so that the first device acquires a second random value and second signature information from a server according to the first random value and the first signature information; and
perform a data interaction with the first device according to the second random value and the second signature information.

16. The apparatus according to claim 15, wherein the processor is further configured to:
receive a request for providing data transmitted by the first device, wherein the request for providing data comprises the second random value and the second signature information, the second random value is configured to generate the second signature information;
perform a signature information comparison on the first signature information and the second signature information according to the first random value, the first signature information, the second random value, and the second signature information, to obtain a comparison result; and
transmit response data to the first device when the comparison result is that the signature information matches.

17. The apparatus according to claim 15, wherein the processor is further configured to:
determine whether it is currently in a pairing mode.

18. The apparatus according to claim 17, wherein the processor is further configured to:
if it is determined that it is currently in the pairing mode, transmit the pairing response to the first device.

19. The apparatus according to claim 18, the processor is further configured to:
switch from the pairing mode to a non-pairing mode.

20. The apparatus according to claim 16, wherein the data interaction is a voice-based data interaction, and the response data is voice data.
